(19) United States
(12) Patent Application Publication
(10) Pub. No.: US 2010/0131135 A1
(43) Pub. Date: May 27, 2010

(54) METHOD AND DEVICE FOR SIMULATING THE DRIVING PROPERTIES OF A DRIVE CONCEPT TO BE DEVELOPED FOR A MOTOR VEHICLE

(75) Inventors: Daniel Jaensch, Berlin (DE); Wilfried Nietschke, Meine (DE); Wolfgang Reimann, Lehrte (DE); Thomas Form, Braunschweig (DE)

Correspondence Address: COLLARD & ROE, P.C., 1077 NORTHERN BOULEVARD, ROSLYN, NY, 11576, US

(73) Assignee: IAV GMBH Ingenieurgesellschaft Auto und Verkehr, Berlin (DE)

(21) Appl. No.: 12/449,497

(22) PCT Filed: Sep. 4, 2008
(86) PCT No.: PCT/DE2008/001490

§ 371 Date: Aug. 11, 2009

(30) Foreign Application Priority Data
Sep. 14, 2007 (DE) 10 2007 044 042.3

(51) Int. Cl. G05B 17/02

(52) U.S. Cl. 701/22

(57) ABSTRACT

The invention relates to a method and an associated device for simulating the driving characteristics of a drive concept to be developed for a motor vehicle. The aim of the invention is to provide a method and an associated device for simulating the driving characteristics of a drive concept to be developed for a motor vehicle, using which the longitudinal dynamics and the energy requirements of designed concepts are simulated, compared with one another and validated during an actual driving operation. According to the invention, in order to simulate the driving characteristics of a drive concept to be developed for a motor vehicle during an actual driving operation for a production vehicle, the engine and transmission control are influenced by means of an additional control unit in such a way that the longitudinal dynamics of the production vehicle correspond to that of a designed hybrid drive. To achieve this, the additional control unit for influencing the longitudinal dynamics of the conventional carrier vehicle intervenes in the signal path of the accelerator pedal in the carrier vehicle and can determine the position of the pedal, simulating the position of a ‘virtual accelerator pedal’ by means of a signal generator, thus regulating the acceleration of the vehicle. The control unit accesses the CAN data bus of the drive train of the carrier vehicle to deliver the current speed, the current gear selected and the position of the brake pedal, which represent important input variables for the simulation.

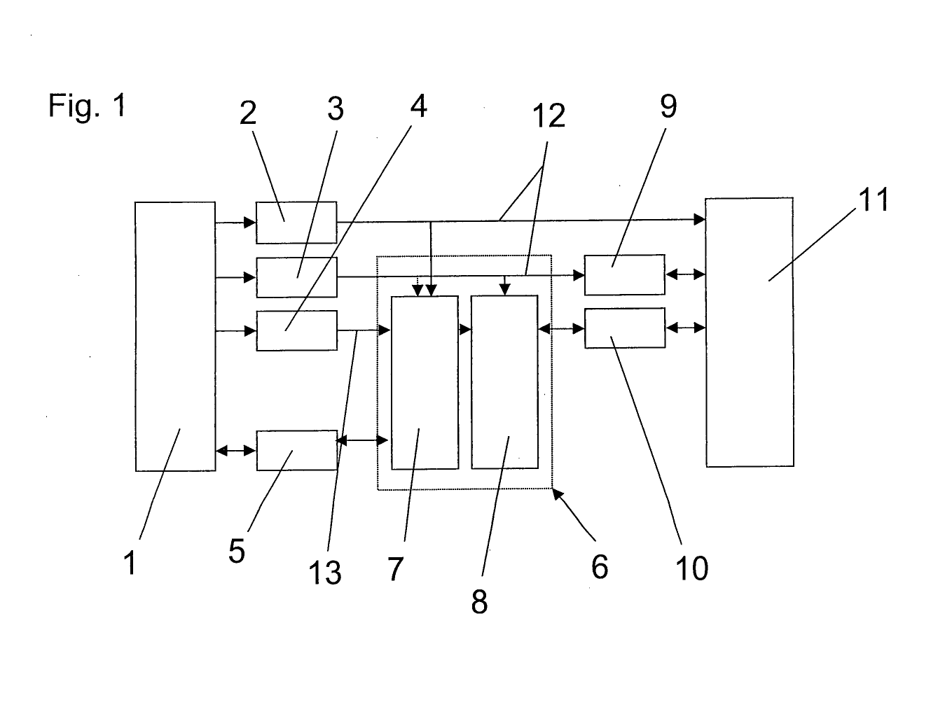

The invention relates to a method for simulating the driving properties of a drive concept to be developed for a motor vehicle, in accordance with the characteristics stated in the preamble of claim 1, as well as to a related device having the characteristics stated in the preamble of claim 13.

With the development of new drive concepts of motor vehicles, the individual drive components, such as transmission, engine, and the like, must be coordinated with one another in such a way that they meet the requirements with regard to good driving performance, driving properties, and driving comfort. For this purpose, it is necessary to conduct corresponding studies in the development stage, as early as possible, in which studies the behavior of the drive components to be developed can be documented.

From DE 197 42 627 C2, a vehicle driving behavior study system having a running conditions simulation device is known, whereby a control unit controls the load torque and the speed of rotation in such a manner that the unit simulates the speed of the machine and thus the running conditions of the vehicle. The control device determines the operating parameters, including speed of rotation and initial torque of the machine, when the latter has a load applied to it by the running conditions simulation device. The operating parameters determined in this connection are converted to driving behavior data, such as the acceleration and vibration of the vehicle, in a driving behavior data production device, using a digital computer, on the basis of a simulation model, and the driving behavior data are converted to stimuli that can be directly perceived by the human senses, such as visible images, sounds, and forces, by means of a sense impression data production device.

A method for tuning a drive train management of a motor vehicle having an internal combustion engine is known from DE 198 21 167 A1. In this connection, the method has the following steps:
setting a quality characteristic field in the case of engine application from the group of emissions and/or fuel consumption and/or exhaust gas temperature in a data processing system,
entering an optimization strategy of the engine tuning and the operating points of the engine characteristic field that are to be optimized into the data processing system,
algorithmically optimizing the engine tuning in the selected operating points in the data processing system, with regard to the selected optimization strategy,
updating the characteristic field with the values received from optimization, in an optimized characteristic field.

It is known from DE 102 36 620 A1 to provide a motor vehicle with a driving test interface to which an electronic driving test device is connected. On a test bench, the drive train is operated by way of the electronic driving test device, at a predetermined driving profile. The driving profile can therefore be precisely run, independent of the driver, whereby the driving profile can be reproducibly re-run again, at any time. The driving profile contains the processes “start up,” “accelerate,” “change gears,” “keep speed constant,” “brake,” and “stop,” in accordance with the desired driving operation. The related operating parameters as well as engine and transmission characteristic values of the driving profile being run, in each instance, can be stored in memory by way of a computer.

A method and a device for determining characteristic fields for controlling a gear-changing process for fully automatic or automated transmissions of a motor vehicle are known from DE 10 2005 013 697 A1. In this connection, the current data of the vehicle acceleration recorded by way of sensors are passed to a separate control device, with which reproducible running of a predetermined driving profile by a motor vehicle takes place, and are stored in memory there, with time synchronicity, with the related operating parameters, in each instance, whereby an objective characteristic value for assessing the gear-changing process, in each instance, is determined in the control device on the basis of the determined progression of the vehicle acceleration during a gear-changing process. If necessary, a subjective characteristic value created by the developer can additionally be stored in the memory of the control device, along with the objective characteristic value for the gear-switching process, in each instance, determined by the control device. Automated application of vehicle parameters relevant to gear-changing comfort takes place by means of the control device or by means of a computer connected with the control device, on the basis of the characteristic values determined.

The invention is based on the task of creating a method and a related device for simulating the driving properties of a drive concept to be developed for a motor vehicle, with which the longitudinal dynamics and the energy requirement of designed drives of a motor vehicle are simulated in real driving operation, compared with one another, and validated.

This task is accomplished, in accordance with the method according to the invention, by means of the characterizing features of claim 1, and, in accordance with the device according to the invention, by means of the characterizing features of claim 13.

According to the invention, the engine control and transmission control are influenced, for simulating the driving properties of a drive concept to be developed for a motor vehicle, in real driving operation of a mass-production vehicle, by means of an additional control device, in such a manner that the longitudinal dynamics of the mass-production vehicle correspond to those of a designed drive. In this connection, the additional control device for influencing the longitudinal dynamics of the conventional carrier vehicle provided for the simulation intervenes in the signal path of the gas pedal of the carrier vehicle, and is able to determine the position of the gas pedal and to issue the setting of a “virtual gas pedal,” by way of which the acceleration of the vehicle is regulated, by way of a signal generator. Access of the control device to the communication of the drive train, for example a CAN data bus, of the carrier vehicle yields the current speed, the current gear that is set, and the position of the gas pedal, which represent important input variables for the simulation. Thus, only two interfaces between vehicle and simulation computer are required, and the integration effort is kept within a minimal framework. Proceeding from the gas pedal and brake pedal position of the carrier vehicle, a simulation computer determines the expected acceleration, in real time, as well as the energy consumption of the drive concept. The acceleration of the carrier vehicle is subsequently adapted to the behavior of the simulation model, as precisely as possible, using an acceleration regulator. This presupposes that the engine power and the torque of the carrier vehicle at least correspond to those of the model in all operating points. An optional operation computer connected with the control device allows the compilation and configuration of the simulation model and allows the developer to optimize the design directly, on-line, in the vehicle.

The advantage of the solution according to the invention consists in that the designed drive concepts can already be compared with one another in the development phase, and thus an optimized solution can be developed. This means, on the one hand, faster development of a vehicle ready for production. On the other hand, costs are saved as the result of not having to produce different prototypes. The simulation therefore closes the time gap between drafting a drive concept and finalizing it with prototypes. In contrast with conventional simulations that are generally based on standardized driving cycles and yield abstract results, the solution according to the invention allows directly determining the longitudinal dynamics of a design as well as studying customer-specific consumption, close to reality, in real driving operation. Another advantage of the solution according to the invention consists in that the simulation models of the drive concepts can be validated in real driving operation, by means of the control device, in a modified mass-production vehicle that serves as the carrier vehicle.

Further advantageous embodiments are described in the dependent claims; they are explained in the specification, along with their effects.

The invention will be explained in greater detail in the following, using a drawing that shows a schematic representation of the solution according to the invention for simulating the driving properties of a drive concept to be developed for a motor vehicle, on the basis of exemplary embodiments.

The invention will be specifically described on the basis of a hybrid drive to be developed. According to the invention, all other designed drives can also be simulated analogously. In the drawing, the integration of an additional control device 6 for simulating the driving properties of a designed hybrid drive by means of a real, drivable mass-production vehicle, is shown. The modified mass-production vehicle thus represents a carrier vehicle with which the driving properties of the designed hybrid drive can be almost precisely duplicated. Of the modified carrier vehicle, a brake pedal 2, a gear selection lever 3, and a gas pedal 4, on the one hand, and a transmission control 9, an engine control 10, and the drive 11 of the vehicle, as well as the connecting data paths, on the other hand, are shown.

The additional control device 6 for simulating the driving properties of a designed hybrid drive requires two interfaces for connection in the modified mass-production vehicle. On the one hand, the control device 6 is connected with the signal path 13 of the gas pedal 4, and, on the other hand, with the communication of the drive train, such as a CAN data bus 12, of the drive train of the vehicle. The control device 6 consists of a simulation computer 7 and a signal generator 8. The control device 6 is connected with an operation computer 5 for inputting and processing the simulation models in the simulation computer 7 of the control device 6 configured as a simulation device.

A simulation model of the designed hybrid drive is loaded into and stored in the memory of the simulation computer 7 of the control device 6, by a driver 1 or by a developer, respectively, by way of the operation computer 5. The compilation and configuration of the simulation model can be processed by the driver 1 by way of the operation computer 5. Furthermore, the operation computer 5 allows the developer to directly optimize the design on-line, in the vehicle. In real driving operation of the modified mass-production vehicle, the engine control 10 and transmission control 9 are influenced by the control device 6 in such a manner that the longitudinal dynamics of the mass-production vehicle correspond to that of the designed hybrid drive.

The modified mass-production or carrier vehicle reproduces the expected longitudinal dynamics, in other words the acceleration of the hybrid drive to be tested, as precisely as possible, and allows both the developer and the potential customer to already test the design practically, directly in traffic, for its everyday usefulness, even without building a prototype. Different designs can be directly compared with one another, by means of simply exchanging the vehicle models stored in memory. The simulation computer 7 integrated into the control device 6 makes it possible—proceeding from the current vehicle speed, the position of the gas pedal 4 and brake pedal 2, and the current transmission translation ratio—to determine the expected acceleration and the energy/fuel demand, using mathematical models of the drive train components of the hybrid drive to be simulated. The carrier vehicle now tries to reproduce this acceleration as precisely as possible, using an acceleration regulator. This allows the driver 1 to be able to directly determine the driving properties of the vehicle to be simulated and the hybrid drive to be simulated.

The longitudinal dynamics of the hybrid drive to be tested, which are determined, are stored in the memory of the simulation computer 7 of the control device 6. By way of the operation computer 5, different available simulation models can be loaded into the simulation computer 7 for reproduction, processed, and configured, for a comparison of the driving properties of the designed hybrid drive. A preferred model can be optimized by means of comparing the different simulation models, and afterwards can be validated.

As already explained above, for a data determination with regard to the current vehicle speed, the control device 6 is already connected with the signal path 13 of the gas pedal 4 of the mass-production vehicle, and with the communication of the drive train, such as a CAN data bus 12. During the test drive of the modified mass-production vehicle, the control device 6 intervenes in the signal path 13 of the gas pedal 4, to simulate the driving properties of the designed hybrid drive, and is able to determine the position of the gas pedal 4 and to set the position of a “virtual gas pedal,” by way of which the acceleration of the vehicle is regulated, by way of a signal generator 8. Access to the CAN data bus 12 of the drive train yields the current speed, the gear currently set, and the position of the brake pedal 2, which represent important input variables for the simulation. Thus, only two interfaces are required between vehicle and control device 6, and the integration effort is kept within a minimal framework.

Using this vehicle, it is already possible to check the acceleration regulator, the simulation models of the hybrid components, the display concept of the operation computer 5, and the safety concept. The representation of the longitudinal dynamics of a hybrid vehicle is made completely possible. The result can already be used in the development and finalization of drive concepts, at high quality. The shortened development time as compared to using a carrier vehicle with a real hybrid drive allows a faster start of the utilization phase.

The drive 11 of the carrier vehicle is greater than the drive power of the hybrid drive to be designed. With this, the result is achieved that the drive 11 of the carrier vehicle meets the performance requirements of the hybrid drive to be tested at all times. The drive 11 of the carrier vehicle can take place by way of an internal combustion engine, by way of an electric motor, or also by way of a hybrid drive. The driving impression of the hybrid drive to be studied can be completely reproduced by means of a hybrid drive used in the carrier vehicle. In addition to purely electric driving, the electric motor also allows depicting the torque increase in boost operation. In this connection, control of the vehicle no longer takes place solely by means of the position of a virtual gas pedal, but rather a special hybrid control device checks the control of the two drive units, depending on the mode of operation of the simulated vehicle, regulates the acceleration to be maintained, and charges the driving battery.

### List of Reference Symbols Used

1 driver

2 brake pedal

3 gear selection lever

4 gas pedal

5 operation computer

6 control device

7 simulation computer

8 signal generator

9 transmission control

10 motor control

11 drive

12 CAN data bus

13 signal path

1. Method for simulating the driving properties of a drive concept to be developed for a motor vehicle, wherein in real driving operation of a mass-production vehicle, the engine control (10) and transmission control (9) are influenced by means of an additional control device (6), in such a manner that the longitudinal dynamics of the mass-production vehicle correspond to those of a designed hybrid drive, whereby a simulation model of the hybrid drive to be designed is stored in the memory of the control device (6).

2. Method according to claim 1, wherein in the control device (6), the expected longitudinal dynamics and the energy and/or fuel demand of the hybrid drive are determined by means of a simulation computer (7), from the current vehicle speed, the position of the gas pedal (4) and the brake pedal (2), and the current transmission translation ratio of the real mass-production vehicle, and the longitudinal dynamics of the hybrid drive that are determined are set on the driving vehicle by means of an acceleration regulator of the motor control (10).

3. Method according to claim 1, wherein the longitudinal dynamics of the hybrid drive that are to be determined are stored in the memory of the simulation computer (7) of the control device (6), as a simulation model.

4. Method according to claim 1, wherein existing simulation models are loaded into the simulation computer (7), by way of an operation computer (5), for reproduction of the driving properties of the hybrid drive to be developed.

5. Method according to claim 1, wherein the simulation models are processed and configured by way of the operation computer (5).

6. Method according to claims 1, wherein in real driving operation, different simulation models of the designed hybrid drives are compared with one another by way of the simulation computer (7), and afterwards are optimized and validated.

7. Method according to claims 1, wherein the control device (6) installed into a mass-production vehicle is connected with the signal path (13) of the gas pedal (4) of the mass-production vehicle, and with the communication of the drive train, such as a CAN data bus (12).

8. Method according to claims 1, wherein the position of a virtual gas pedal is set by way of the control device (6) and a signal generator (8), to regulate the acceleration of the vehicle.

9. Method according to claims 1, wherein the drive power of the mass-production vehicle is greater than that of the hybrid drive to be developed.

10. Method according to claim 1, wherein the drive (11) of the mass-production vehicle takes place by way of an internal combustion engine.

11. Method according to claims 1, wherein the drive (11) of the mass-production vehicle takes place by way of an electric motor.

12. Method according to claim 1, wherein the drive (11) of the mass-production vehicle takes place by way of a hybrid drive.

13. Device for simulating the driving properties of a drive concept to be developed for a motor vehicle, wherein in a real mass-production vehicle, an additional control device (6) is provided to influence the longitudinal dynamics of the mass-production vehicle, with which device the longitudinal dynamics of the mass-production vehicle are set in such a manner that they correspond to those of a designed hybrid drive.

14. Device according to claim 13, wherein the additional control device (6) is connected with the signal path (13) of the gas pedal (4) of the mass-production vehicle, and with the communication of the drive train, for example a CAN data bus (12).

15. Device according to claim 12, wherein the control device (6) contains a simulation computer (7) for setting the longitudinal dynamics of the designed hybrid drive, for comparing different simulation models with one another, and for storing the data in memory and validating them.

16. Device according to claims 13, wherein the control device (6) is connected with an operation computer (5) for processing and configuring the simulation models.

17. Device according to claims 13, wherein the drive (11) of the mass-production vehicle is an internal combustion engine.

18. Device according to claims 13, wherein the drive (11) of the mass-production vehicle is an electric motor.

19. Device according to claim 13, wherein the drive (11) of the mass-production vehicle is a hybrid drive.
